(19) United States
(12) Patent Application Publication
(10) Pub. No.: US 2025/0326228 A1
(43) Pub. Date: Oct. 23, 2025

(54) LIQUID CONTAINER

(71) Applicant: CANON KABUSHIKI KAISHA, Tokyo (JP)

(72) Inventors: HIROSHI INOMATA, Kanagawa (JP); KATSUMI EDA, Tokyo (JP)

(21) Appl. No.: 19/182,346

(22) Filed: Apr. 17, 2025

(30) Foreign Application Priority Data
Apr. 23, 2024 (JP) 2024-069692

(51) Int. Cl. B41J 2/175

(52) U.S. Cl. CPC B41J 2/17513; B41J 2/17553; B41J 2002/17516

(57) ABSTRACT

A liquid container includes a liquid-containing bag that contains a liquid, a joining member that communicates with the liquid-containing bag and is connected to an apparatus that consumes the liquid contained in the liquid-containing bag, and a protective member that accommodates the liquid-containing bag and includes a barrier function that suppresses permeation of the liquid contained in the liquid-containing bag.

### BACKGROUND

### Field The present disclosure relates to a liquid container.

### Description of the Related Art

In printing apparatuses, to supply a liquid such as ink to a print head, a liquid container containing a liquid is housed in a replaceable manner. Such a liquid container includes, for example, a liquid-containing bag for containing a liquid, and a protective case for accommodating the liquid-containing bag and protecting the accommodated liquid-containing bag from vibration during transportation and shock if dropped.

Japanese Patent Laid-Open No. 2013-129101 discloses a liquid container in which a liquid-containing bag made of a multilayer film with a barrier function is protected by a protective case made of cardboard.

From the standpoint of recyclability, the liquid container described in Japanese Patent Laid-Open No. 2013-129101 enables its paper case to be collected and reused. However, the liquid-containing bag is soft, and tiny cracks may occur in the barrier layer due to vibration or shock, which makes reuse difficult.

### SUMMARY

The present disclosure is made in view of the above-described issue, and provides a liquid container equipped with a barrier function and whose liquid-containing bag can be reused.

A liquid container includes a liquid-containing bag configured to contain a liquid, a joining member configured to communicate with the liquid-containing bag and connected to an apparatus that consumes the liquid contained in the liquid-containing bag, and a protective member configured with a barrier function for suppressing permeation of the liquid contained in the liquid-containing bag and configured to accommodate the liquid-containing bag.

According to the present disclosure, a liquid container is equipped with a barrier function where a liquid-containing bag can be reused.

Further features of the present disclosure will become apparent from the following description of exemplary embodiments with reference to the attached drawings.

### BRIEF DESCRIPTION OF THE DRAWINGS

FIG. 1 is a perspective view of a printing apparatus using a liquid container.

FIG. 2A and FIG. 2B are schematic configuration diagrams of the liquid container.

FIG. 3A to FIG. 3D are diagrams illustrating the configuration of a protective member.

FIG. 4 is a perspective configuration diagram of a liquid intake part.

FIG. 5A to FIG. 5C are diagrams illustrating the configuration of a joining member.

FIG. 6A and FIG. 6B are diagrams illustrating the configuration of a communication plug.

FIG. 7 is a schematic configuration diagram of a liquid container according to another embodiment.

### DESCRIPTION OF THE EMBODIMENTS

Hereinafter, examples of an embodiment of the liquid container are described with reference to the accompanying drawings. The following embodiments are not intended to be limiting, and every combination of the characteristics described in the following embodiments is not necessarily essential to the solution provided in the present disclosure. The positions, shapes, etc., of the constituent elements described in the following embodiments are merely examples and are not intended to be limiting.

The technologies described in this specification have the potential to contribute to the achievement of a sustainable society, such as a decarbonized society/circular society. The present disclosure discusses, as a technology that has the potential to contribute to the achievement of such a sustainable society, a liquid container whose liquid-containing bag can be reused.

### First Embodiment

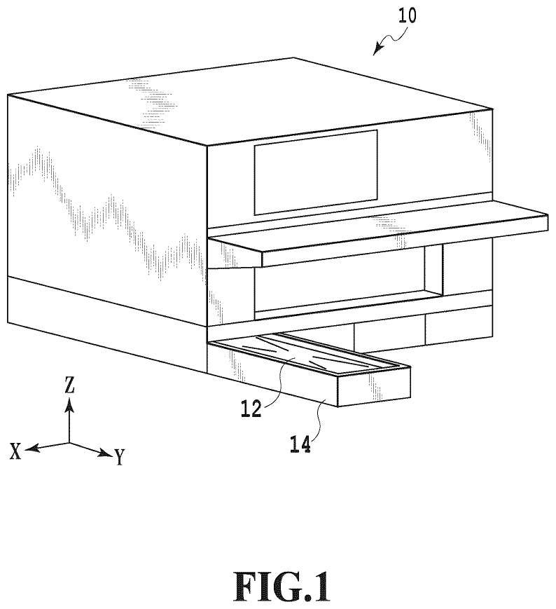

A description of a liquid container according to a first embodiment will now be provided with respect to FIG. 1 to FIG. 6B.

### <Printing Apparatus>

First, a description is provided regarding a printing apparatus that houses a liquid container in a replaceable manner according to the present embodiment. FIG. 1 is a perspective configuration diagram of a printing apparatus that houses a liquid container in a replaceable manner according to the present embodiment. For description purposes, as viewed facing the printing apparatus 10 of FIG. 1, the width direction of the printing apparatus 10 is described as the X direction, the depth direction of the printing apparatus 10 is described as the Y direction, and the height direction of the printing apparatus 10 is described as the Z direction. In addition, the liquid container is described using the orientation of the liquid container being housed in the printing apparatus 10.

The printing apparatus 10 is configured to perform printing by ejecting a liquid, such as ink, from a print head (not illustrated) onto a print medium conveyed by a conveyance part (not illustrated). The printing apparatus 10 is equipped with a housing part 14 that houses, in a replaceable manner, a liquid container 12 containing the liquid. In the printing apparatus 10, the liquid container 12 housed in the housing part 14 is connected to the print head so that the liquid contained in the liquid container 12 is transferred from the liquid container 12 to the print head via a pump (not illustrated) or the like. Thus, the amount of liquid contained in the liquid container 12 decreases in response to printing by the print head.

The housing part 14 is installed to be movable in the Y direction to move between a replacement position (the position illustrated in FIG. 1) where the liquid container 12 can be replaced, and a supply position, positioned within the housing of the printing apparatus 10, where the ink can be supplied from the housed liquid container 12 to the print head. In the printing apparatus 10, the liquid container 12 is configured to be housed near a bottom section on a front side of the printing apparatus 10, but this is not seen to be limiting. The configuration (the housing part 14) for housing the liquid container 12 may be changed as appropriate depending on the internal configuration of the printing apparatus 10. For example, to an upper part on a rear side or an upper part on one side.

### <Liquid Container>

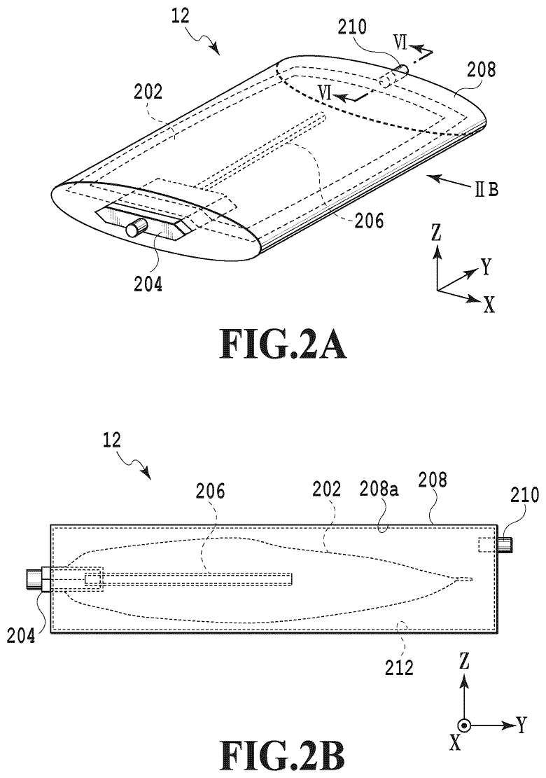

Next, a description is provided regarding the configuration of the liquid container 12. FIG. 2A and FIG. 2B are schematic configuration diagrams of the liquid container 12. FIG. 2A is a perspective view while FIG. 2B is an arrow view of IIB of FIG. 2A.

The liquid container 12 includes a liquid-containing bag 202 for containing a liquid, a joining member 204 for joining to the printing apparatus 10, and a liquid intake part 206 that can take in the liquid contained in the liquid-containing bag 202 by communicating with the joining member 204. The liquid container 12 also includes a protective member 208 that covers and protects the outside of the liquid-containing bag 202, and a communication plug 210 that introduces outside air into the protective member 208.

### <Liquid-Containing Bag>

The liquid-containing bag 202 is a pillow-type bag formed by stacking two flexible films and joining their peripheries by welding or the like. The liquid-containing bag 202 is not limited to this structure, and various known bags that can deform based on the amount of liquid contained may be used. For example, a so-called gusset bag, which has gussets formed at both ends in the X direction, or a bag formed by welding a single sheet into a cylindrical shape are applicable.

The liquid-containing bag 202 is composed of a film laminated with multiple layers, such as a polyester layer, a nylon layer, and a polyethylene layer, and has a bag shape to contain liquid. The layer configuration of the film may be appropriately changed depending on the type of liquid to be contained. In the present embodiment, the size of the liquid-containing bag 202 is 120 mm in the X direction and 220 mm in the Y direction, but this is not seen to be limiting.

### <Protective Member>

The protective member 208 is formed from cardboard with a thickness of 1.5 mm, but this is not seen to be limiting. The protective member 208 is not limited to being formed from cardboard, and any other type of strong paper, such as paperboard, may be used. Alternatively, biodegradable plastics or the like may be used.

In the present embodiment, the liquid-containing bag 202 itself is not equipped with a function to suppress liquid permeation (evaporation) (hereinafter referred to as a “barrier function”). Therefore, if the liquid-containing bag 202 is left in a state containing liquid, the liquid may permeate through each layer of the film constituting the liquid-containing bag 202 and evaporate external to the liquid-containing bag 202, which may result in a decrease in the amount of liquid contained and an increase in the viscosity of the contained liquid. If a decrease in the amount of liquid contained in the liquid-containing bag 202 or an increase in the viscosity of the contained liquid occurs, there is a possibility that the printing performance of the printing apparatus 10 using the liquid-containing bag 202 may be affected.

To address this, the protective member 208 includes a material with a barrier function arranged on an internal surface 208a, which faces the liquid-containing bag 202. In the present embodiment, an aluminum foil 212 is laminated on the internal surface 208a. Thus, the liquid-containing bag 202 accommodated within the protective member 208 is insulated from external air. The material with a barrier function may be arranged on an outer surface 208b of the protective member 208. The material with a barrier function may be any from among various known materials, such as a film formed by depositing a ceramic-based material onto a PET film.

In the present embodiment, cardboard or paperboard is used as the material for forming the protective member 208 as part of efforts to reduce the use of plastic, but this is not seen to be limiting. For example, a material such as plastic or metal that has the effect of insulating the liquid-containing bag 202 accommodated therein from external air may be used.

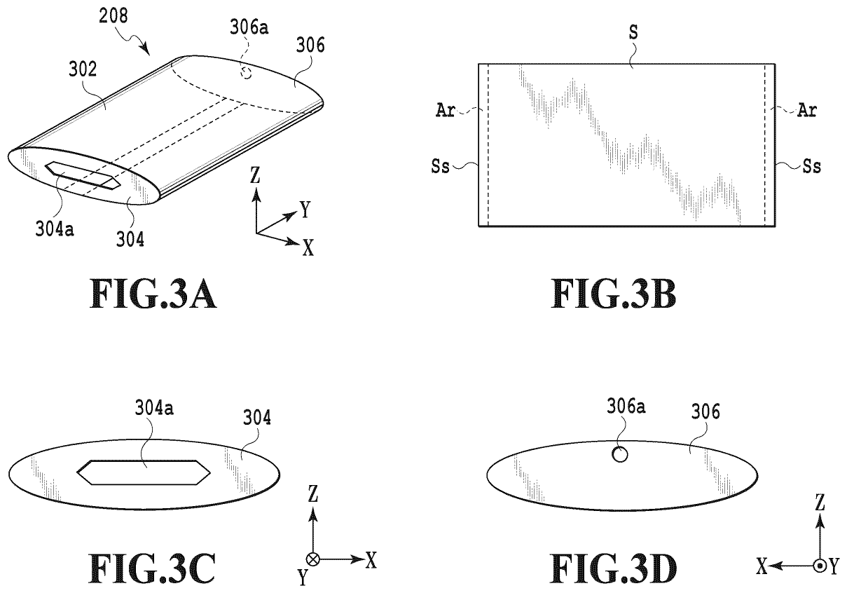

A detailed description will now be provided regarding the configuration of the protective member 208. FIG. 3A to FIG. 3D are diagrams illustrating the configuration of the protective member 208,. FIG. 3A illustrates an external view of the protective member 208, FIG. 3B illustrates a developed view of a body part 302 of the protective member 208, FIG. 3C illustrates a side view of one side of the protective member 208, and FIG. 3D illustrates a side view of the other side of the protective member 208.

The protective member 208 includes the body part 302, a side surface part 304 where an opening part 304a through which the joining member 204 is inserted is formed, and a side surface part 306 where an opening part 306a through which the communication plug 210 is inserted is formed. The body part 302 is formed into a substantially elliptical cylindrical shape by bonding areas Ar on two opposing short sides Ss of a single sheet- shaped material S (cardboard in the present embodiment) using an adhesive agent or the like. The side surface part 304 is bonded and fixed to one side of the substantially elliptical cylindrical shaped opening portions of the body part 302, while the side surface part 306 is bonded and fixed to the other side of the substantially elliptical cylindrical shaped opening portions of the body part 302.

In the present embodiment, the protective member 208 is formed into a hollow, substantially elliptical cylindrical shape by the body part 302 and the side surface parts 304 and 306. This is because, in a case of a shape formed with a folded portion, such as a rectangular column shape, the barrier function of the aluminum foil 212 laminated to the internal surface 208a of the protective member 208 may be reduced due to crease line parts that serve as folding guides or by the folding itself. If it is possible to suppress a decrease of the barrier function by, for example, improving the folding method or thickening the aluminum foil 212 at the folded portions, the protective member 208 may be formed into a rectangular column shape.

The joining member 204 is fixed to the side surface part 304 in a state being inserted through the opening part 304a. A sealing agent, an adhesive agent, or the like may be used for the fixing method. To suppress a decrease of the barrier function of the protective member 208, a gap should not be formed in the joining portion between the joining member 204 and the opening part 304a. The communication plug 210 is fixed to the side surface part 306 in a state being inserted through the opening part 306a. A sealing agent, an adhesive agent, or the like may be used for the fixing method. To suppress a decrease of the barrier function of the protective member 208, a gap should not be formed in the joining portion between the communication plug 210 and the opening part 306a.

### <Liquid Intake Part>

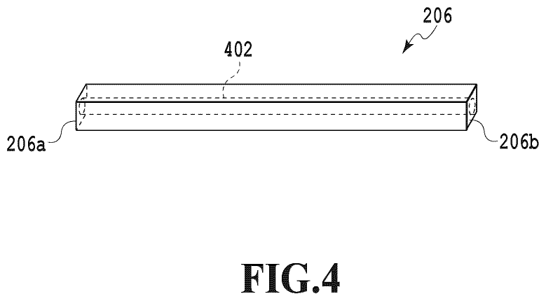

FIG. 4 is a perspective configuration diagram of the liquid intake part 206. The liquid intake part 206 is formed from a resin material such as polyester or polypropylene, and is formed into a straight tubular shape. In the present embodiment, the liquid intake part 206 has a substantially rectangular tubular shape, and a flow path 402, which has a substantially circular cross-sectional shape, is formed from the end part 206a on one side in the extending direction to the end part 206b on the other side. The end part 206a on the one side of the liquid intake part 206 is joined to the joining member 204, and the end part 206b on the other side is positioned at a substantially central position in the Y direction within the liquid-containing bag 202 (see FIG. 2B). This enables the liquid intake part 206 to take in the liquid contained in the liquid-containing bag 202 from the end part 206b on the other side, and guide the liquid taken in to the joining member 204. The liquid intake part 206 is not limited to the above-described shape as long as its configuration enables the liquid in the liquid-containing bag 202 to flow into the joining member 204. The material for the liquid intake part 206 is not limited to the above-described materials as long as the material is resistant to the liquid contained in the liquid-containing bag 202.

### <Joining Member>

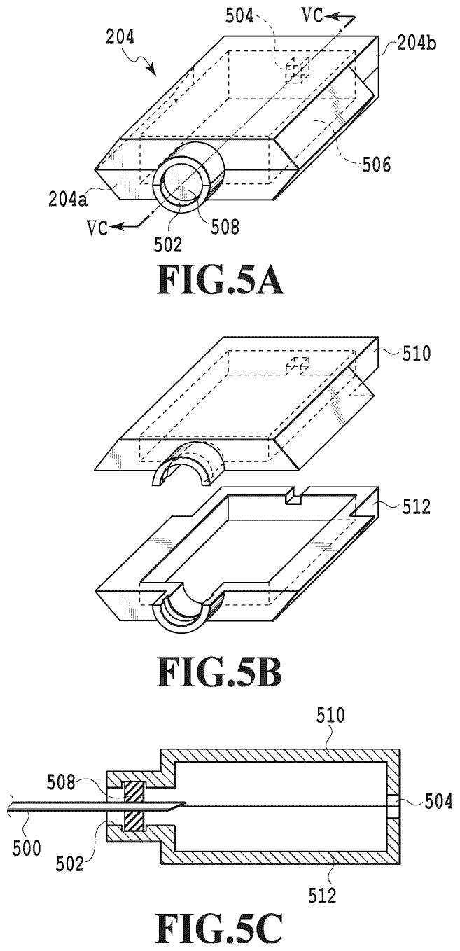

FIG. 5A to FIG. 5C are diagrams illustrating the configuration of the joining member 204. FIG. 5A illustrates a perspective view, FIG. 5B illustrates an exploded view, and FIG. 5C illustrates a diagram corresponding to the cross section taken along line VC-VC of FIG. 5A, in which a needle 500 for supplying the liquid in the liquid container 12 to the printing apparatus 10 is inserted. The joining member 204 is equipped with an opening part 502, into which the needle 500 for supplying the liquid in the liquid container 12 to the printing apparatus 10 is inserted, at the end part 204a on the one side that is exposed external to the protective member 208. The joining member 204 is also equipped, at the end part 204b on the other side positioned within the liquid-containing bag 202, with an insertion port 504 through which the end part 206a on the one side of the liquid intake part 206 is inserted, and a reservoir part 506 that communicates with the insertion port 504 and the opening part 502 and can reserve liquid.

In the joining member 204, the liquid intake part 206 is fixed at the insertion port 504 by an adhesive agent or the like. This enables the reservoir part 506 provided in the joining member 204 to communicate with the flow path 402 of the liquid intake part 206, enabling the liquid taken in the flow path 402 to flow into the reservoir part 506. A gasket 508 made of an elastomer, such as rubber, is installed within the opening part 502 to restrict the liquid reserved in the reservoir part 506 from flowing out of the opening part 502. The joining member 204 is formed by joining members 510 and 512, and with the gasket 508 placed inside the opening part 502, the two members 510 and 512 are fixed together with the gasket 508 by welding or adhesion. The needle 500 has a hollow structure, and once the needle 500 is inserted into the gasket 508, the liquid reserved in the reservoir part 506 can flow out to the printing apparatus 10 through the needle 500. Since the gasket 508 is made of an elastomer, the needle 500 can be inserted and removed, and the gasket 508 is configured to prevent liquid leakage from the inserted and removed portions during and after insertion and removal of the needle 500.

### <Communication Plug>

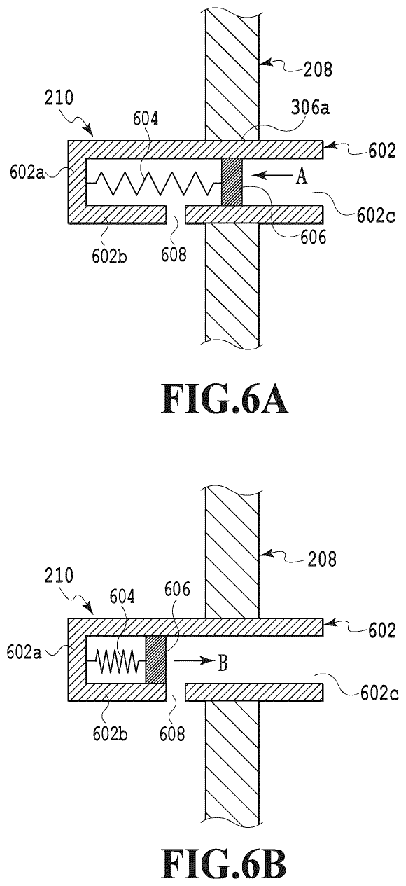

FIG. 6A and FIG. 6B are diagrams illustrating the communication plug 210. FIG. 6A is a diagram corresponding to the cross section taken along line VI-VI of FIG. 2A with the communication plug 210 in a state where the inside and outside of the protective member 208 are not in communication. FIG. 6B is a diagram corresponding to the cross section taken along line VI-VI of FIG. 2A with the communication plug 210 in a state where the inside and outside of the protective member 208 are in communication with each other.

In the liquid container 12, as the liquid contained in the liquid-containing bag 202 decreases, the volume of the liquid-containing bag 202 decreases. In the liquid container 12, the liquid-containing bag 202 is in a state insulated from external air by the protective member 208 laminated with the aluminum foil 212. Therefore, at the time the liquid-containing bag 202 is deformed due to a reduction in volume, it is necessary to reduce the negative pressure inside the protective member 208 caused by the deformation. In the liquid container 12, the communication plug 210 has the function of reducing the negative pressure inside the protective member 208 that occurs as the liquid-containing bag 202 deforms due to a reduction in volume.

The communication plug 210 is configured to enable external air to be introduced into the protective member 208 based on the deformation of the liquid-containing bag 202. Specifically, the communication plug 210 includes a hollow, substantially cylindrical main body part 602 that has an opening 602c formed at one end part, and a lid part 606 biased within a main body part 602 by a biasing member 604, such as a spring.

The main body part 602 is formed with one side in the extending direction closed by the wall surface 602a and the other side opened by the opening 602c. The main body part 602 has a through hole 608 formed in a side surface 602b extending in the extending direction. In the present embodiment, the diameter of the through hole 608 is 1 mm. The lid part 606 is installed to be slidable along the inner wall of the side surface 602b of the main body part 602 and is configured so that external air does not flow in, or hardly flows in, from the contact surface between the lid part 606 and the side surface 602b. The contact surface between the lid part 606 and the main body part 602 may be, for example, coated with a substance that decreases friction or improves sealing performance. The lid part 606 is formed, for example, of fluororubber, but other materials may be used as long as the slidability and sealing performance required for the lid part 606 to function are secured.

The biasing member 604 is installed between the wall surface 602a and the lid part 606 to bias the lid part 606 in a direction away from the wall surface 602a. The lid part 606 is designed to be positioned on the opening 602c side of the through hole 608 in the state biased by the biasing member 604. As the main body part 602 is fixed to the opening part 306a (see FIG. 3A), the wall surface 602a side is positioned inside the protective member 208, and the opening 602c side is positioned outside the protective member 208. At this time, the through hole 608 is also positioned inside the protective member 208. Also at this time, the main body part 602 and the opening part 306a are sealed with an adhesive agent or the like to prevent external air from flowing into the protective member 208.

While the liquid contained in the liquid-containing bag 202 is not being consumed, the lid part 606 of the communication plug 210 is positioned on the opening 602c side of the through hole 608 (see FIG. 6A). In this state, the lid part 606 is positioned between the through hole 608 and the opening 602c, and the communication plug 210 is in a state that insulates the external air.

As the liquid contained in the liquid-containing bag 202 is consumed, the pressure inside the protective member 208 becomes negative with a decrease in the volume of the liquid-containing bag 202. Once the negative pressure inside protective member 208 reaches or exceeds a predetermined level, the lid part 606, which separates the inside and outside of the protective member 208 in the communication plug 210, moves in the direction of arrow A (see FIG. 6A) against the biasing force of the biasing member 604. Due to this movement, once the lid part 606 moves to the wall surface 602a side of the through hole 608, the through hole 608 and the opening 602c communicate with each other in the communication plug 210. This enables the inside and outside of the protective member 208 to communicate with each other, enabling external air to flow into the protective member 208.

As the negative pressure inside the protective member 208 is reduced by the external air flowing into the protective member 208, the lid part 606 moves in the direction of arrow B (see FIG. 6B) due to the biasing force of the biasing member 604. Due to this movement, once the lid part 606 moves to the opening 602c side of the through hole 608, the through hole 608 and the opening 602c are no longer in communication with each other in the communication plug 210. This insulates the inside and outside of the protective member 208, and restricts the external air from flowing into the protective member 208. Thus, in the present embodiment, the communication plug 210 functions as a plug member that switches between communication and insulation of the inside and outside of the protective member 208 based on the pressure inside the protective member 208.

Before external air flows into the protective member 208 through the communication plug 210, the inside of the protective member 208 is in a saturated state (or a state close to a saturated state) with the evaporated components of the liquid contained in the liquid-containing bag. Therefore, external air flowing into the protective member 208 through the communication plug 210 eliminates the saturated state of the evaporated components, so the liquid within the liquid-containing bag 202 evaporates in an amount equal to the volume of the external air that flowed in. Therefore, the amount of evaporation of the liquid contained in the liquid-containing bag 202 is based on the inflow of external air into the protective member 208 through the communication plug 210, and since the evaporation is completed inside the protective member 208, the amount of evaporation is within an expected range.

Based on the above, the density of the liquid contained in the liquid-containing bag 202 is set taking into consideration the expected maximum amount of evaporation based on the inflow of external air into the protective member 208 via the communication plug 210. The communication plug 210 is installed in the protective member 208 at a position that does not interfere with the configuration of the housing part 14 or the printing apparatus 10 at the time the protective member 208 is housed in the housing part 14. The communication plug 210 is installed in the protective member 208 at a position inside the protective member 208 where interference with the liquid-containing bag 202 is not likely.

<Refilling Liquid into the Liquid Container>

As the liquid contained in the liquid-containing bag 202 in the liquid container 12 is consumed and becomes less than or equal to a predetermined amount, the liquid container 12 is removed from the printing apparatus 10 and collected. The liquid can then be refilled into the liquid-containing bag 202. Specifically, since a small amount of liquid remains inside the liquid-containing bag 202 in the liquid container 12 after collection, the joining member 204, the liquid intake part 206, and the inside of the liquid-containing bag 202 are first washed and dried. Then, the inside of the liquid-containing bag 202 is depressurized via the joining member 204 to minimize the amount of air left inside the liquid-containing bag 202 as much as possible at the time of refilling, and then refilling of the liquid is performed. At the time of depressurization and refilling, a needle or the like is inserted into the gasket 508, and after depressurization and refilling, the hole formed by the needle or the like is sealed using, for example, a sealing agent.

### <Functional Effect>

In liquid containers using known technologies, a barrier layer is provided in the liquid-containing bag that contains a liquid in order to suppress evaporation, where the barrier layer is prone to damage from vibration during transportation and shock if dropped. This raises the possibility that the liquid-containing bag can no longer be reused. The liquid-containing bag may become wrinkled due to deformation of the liquid-containing bag as the liquid is consumed, and the occurrence of these wrinkles may damage the barrier layer, making it impossible to reuse the liquid-containing bag.

In contrast, in the liquid container 12 according to the present embodiment, the aluminum foil 212 is laminated as a barrier layer onto the protective member 208, which does not deform due to consumption of liquid and is also unlikely to deform due to shock, vibration, and the like. Therefore, in the liquid container 12 of the present disclosure, compared to liquid containers using known technologies, the barrier layer is less likely to be damaged due to vibration during transportation, dropping, etc., or due to the consumption of liquid. As a result, the liquid-containing bag 202 in the collected liquid container 12 can maintain the performance of the liquid-containing bag 202 in the liquid container 12 prior to use, enabling the liquid-containing bag 202 in the collected liquid container 12 to be reused.

### Second Embodiment

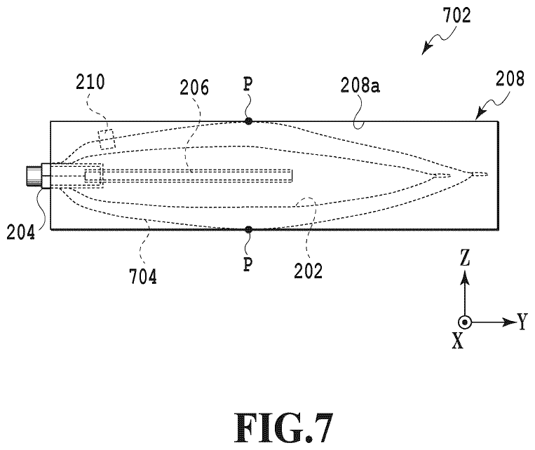

Next, a description of a liquid container according to a second embodiment will be provided with reference to FIG. 7. In the following description, the same or corresponding configurations as those of the liquid container according to the first embodiment are assigned the same reference numbers as those used in the first embodiment, and a detailed descriptions will be omitted herein.

The liquid container according to the second embodiment differs from the liquid container 12 according to the first embodiment in that, instead of laminating the aluminum foil 212 to the internal surface 208a of the protective member 208, the liquid-containing bag 202 is installed inside a bag part with a barrier function.

### <Liquid Container>

FIG. 7 illustrates a side view of the liquid container 702 according to the second embodiment, and corresponds to FIG. 2B. A liquid container 702 in FIG. 7 includes a bag part 704 that has a barrier function between the protective member 208, which does not have the aluminum foil 212 as a barrier layer on the internal surface 208a, and the liquid-containing bag 202, which contains the liquid.

In the present embodiment, a bag part 704 has flexibility and covers the liquid-containing bag 202 along with a part of the joining member 204 inside the protective member 208. The bag part 704 is laminated with aluminum or the like to have the barrier function. Since the liquid container 702 does not have the aluminum foil 212 provided on the protective member 208, the cross section of the protective member 208 does not need to be in a substantially elliptical shape and may instead be in a rectangular shape with bent portions formed.

In the liquid container 702, the communication plug 210 is installed in the bag part 704. To take into consideration the effects of shock, the function of external communication and insulation for blocking it, etc., the communication plug 210 is preferably installed at a position where interference from the liquid-containing bag 202 is unlikely. In the present embodiment, the communication plug 210 is installed between the joining member 204 and fixing parts P (described below), which fix the bag part 704 to the protective member 208, where a clearance can be easily ensured between the liquid-containing bag 202 and the bag part 704. The installation position of the communication plug 210 in the bag part 704 is not limited to the position described above, and may be changed as appropriate based on the shapes of the bag part 704, the protective member 208, the communication plug 210, and the like.

In the present embodiment, in the liquid container 702, the communication plug 210 functions as a plug member that switches between communication and insulation of the inside and outside of the bag part 704 based on the pressure inside the bag part 704. Therefore, in the liquid container 702, the protective member 208 does not have a high degree of sealing performance, and its configuration enables external air to flow into the inside of the protective member 208 at all times.

The bag part 704 is fixed to the internal surface 208a of the protective member 208 at positions substantially in the center of the protective member 208 in the extending direction (the Y direction). That is, the bag part 704 is fixed to the internal surface 208a at the fixing parts P. As a result, it is possible to suppress damage to the liquid-containing bag 202 caused by vibration and shock. In a case where the bag part 704 is formed thick enough to suppress damage to the liquid-containing bag 202 due to vibration and shock, there is no need to fix the bag part 704 to the protective member 208.

In the liquid container 702, the bag part 704 is installed inside the protective member 208, and the liquid-containing bag 202 is installed inside the bag part 704. Accordingly, compared with the volume between the liquid-containing bag 202 and the protective member 208 on which the barrier layer of the liquid container 12 is formed, the volume between the liquid-containing bag 202 and the bag part 704, which is equipped with the barrier function of the liquid container 702, is smaller. Therefore, the total amount of external air flowing in from the communication plug 210 as the liquid within the liquid-containing bag 202 is consumed is smaller in the liquid container 702 than in the liquid container 12. For this reason, the amount of evaporation of the liquid from the liquid-containing bag 202 is smaller in the liquid container 702 than in the liquid container 12, and the change in the density of the liquid contained in the liquid-containing bag 202 is reduced. This enables the implementation of more stable printing in the printing apparatus 10. It is possible to refill the liquid in the liquid container 702 in the same manner as the liquid container 12.

### <Functional Effect>

As described above, in the configuration of the present embodiment, the liquid-containing bag 202 is accommodated within the bag part 704, which is equipped with a barrier function, inside the protective member 208. As a result, the liquid container 702 according to the present embodiment provides the same functional effect as the liquid container 12 according to the first embodiment, and additionally achieves the functional effect of reducing the change in the density of the contained liquid and improving freedom in the shape of the protective member 208.

### Other Embodiments

The above-described embodiments may be modified as shown in the following (1) through (4).
(1) In the above-described embodiments, the communication plug 210 is configured so that the inside and outside of the protective member 208 (the bag part 704) communicate by having the lid part 606 move against the biasing force of the biasing member 604 according to depressurization inside the protective member 208 (the bag part 704). However, this is not seen to be limiting. Any configuration is acceptable as long as the inside and outside are in communication as the pressure inside the protective member 208 (the bag part 704) becomes less than or equal to a predetermined value, and the inside is insulated from the outside as the pressure exceeds the predetermined value.
(2) In the above-described embodiments, the communication plug 210 is installed. However, this is not seen to be limiting, and the communication plug 210 may not be installed. For example, the volume of the bag part 704 is larger than the volume of the liquid-containing bag 202, and the volume of the bag part 704 decreases based on the decrease in the volume of the liquid-containing bag 202, so the bag part 704 is less likely to wrinkle than the liquid-containing bag 202. For this reason, the barrier function is less likely to decrease due to such wrinkles. Therefore, based on the volume ratio with respect to the liquid-containing bag 202, it is possible to not have the communication plug 210 arranged in the bag part 704.
(3) In the above-described embodiments, the liquid containers 12 and 702 are configured to contain a liquid such as ink for printing performed by the printing apparatus 10. However, this is not seen to be limiting. Containing a liquid to be used in various types of processing apparatuses that perform a predetermined process using liquid is also possible.
(4) The above-described embodiments and various forms shown in (1) through (3) may be combined as appropriate.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-069692, filed Apr. 23, 2024, which is hereby incorporated by reference wherein in its entirety.

What is claimed is:

1. A liquid container comprising:
a liquid-containing bag configured to contain a liquid;
a joining member configured to communicate with the liquid-containing bag and connected to an apparatus that consumes the liquid contained in the liquid-containing bag; and
a protective member configured with a barrier function for suppressing permeation of the liquid contained in the liquid-containing bag and configured to accommodate the liquid-containing bag.

2. The liquid container according to claim 1, wherein a material with a barrier function is placed on an inner surface of the protective member that faces the liquid container.

3. The liquid container according to claim 2, wherein the protective member has aluminum foil laminated on the inner surface.

4. The liquid container according to claim 1 further comprising a plug member configured to switch between communication and insulation of the inside and outside of the protective member based on pressure inside the protective member.

5. The liquid container according to claim 4, wherein the plug member is installed at a position that does not interfere with the apparatus in a state accommodated within the apparatus.

6. The liquid container according to claim 1,
wherein the protective member has a substantially elliptical cylindrical shape.

7. The liquid container according to claim 1, wherein the protective member is formed of cardboard or paperboard.

8. The liquid container according to claim 1, wherein the joining member is configured to enable insertion and removal of a hollow needle and includes a gasket that reduces liquid leakage from a portion where the hollow needle is inserted and removed during and after the insertion and removal.

9. A liquid container comprising:
a liquid-containing bag configured to contain a liquid;
a joining member configured to communicate with the liquid-containing bag and connected to an apparatus that consumes the liquid contained in the liquid-containing bag;
a bag part configured to accommodate the liquid-containing bag internally and configured with a barrier function for suppressing permeation of the liquid contained in the liquid-containing bag; and
a protective member configured to accommodate the liquid-containing bag and the bag part,
wherein the bag part is fixed to the joining member at one end part in an extending direction, and
wherein the bag part is fixed to the protective member at a substantially central position in the extending direction.

10. The liquid container according to claim 9 further comprising a plug member configured to switch between communication and insulation of the inside and outside of the bag part based on pressure inside the bag part.

11. The liquid container according to claim 9 further comprising a plug member configured to switch between communication and insulation of the inside and outside of the bag part based on pressure inside the bag part, wherein the plug member is installed between the joining member and a fixing part where the bag part is fixed to the protective member.

12. The liquid container according to claim 9, wherein the protective member has a substantially elliptical cylindrical shape.

13. The liquid container according to claim 9, wherein the protective member is formed of cardboard or paperboard.

14. The liquid container according to claim 9, wherein the joining member is configured to enable insertion and removal of a hollow needle and includes a gasket that reduces liquid leakage a portion where the hollow needle is inserted and removed during and after the insertion and removal.
